(19) United States
(12) Patent Application Publication
(10) Pub. No.: US 2003/0085213 A1
(43) Pub. Date: May 8, 2003

(54) Apparatus for perforating and deforming a sheet-like structure

(76) Inventors: Christoph Burckhardt, Arlesheim (CH); Christoph Ulmer, Basel (CH); Markus Pluss, Binningen (CH); Bruno Johl, Rombach (CH); Francis Wisson, St. Louis (FR)

Correspondence Address: P. Weston Musselman, Jr., JENKENS & GILCHRIST, P.C., Suite 3200, 1445 Ross Avenue, Dallas, TX, 75202, US

(21) Appl. No.: 10/267,316

(22) Filed: Oct. 9, 2002

Related U.S. Application Data
(62) Division of application No. 09/553,707, filed on Apr. 20, 2000.

(30) Foreign Application Priority Data
Apr. 22, 1999 (EP) EP 99810336.0
Mar. 14, 2000 (EP) EP 00810214.7

(51) Int. Cl. H05B 3/02

(52) U.S. Cl. 219/243

(57) ABSTRACT

An apparatus according to the invention comprises a needle roll (1) and a perforated roll (2), between which a sheet-like structure (3) can be perforated and deformed. The needle roll (1) has a large number of needles (11), while the perforated roll (2) is provided with a large number of holes (21) to accommodate needles (11) of the needle roll (1). The needle roll (1) and the perforated roll (2) are formed and arranged such that during the perforating and deforming operations, each needle (11) in the perforating and deforming area penetrates into a hole (21) in the perforated roll (2). In this way, the sheet-like structure (3) located between them is not only perforated, but the edges of the holes in the sheet-like structure (3) are also shaped three-dimensionally in a controlled way between the needles (11) and the edges of the holes in the perforated roll (2).

The present invention relates to an apparatus for perforating and deforming a sheet-like structure, having a perforating element with a large number of perforating projections and having a mating element which has a large number of holes to accommodate perforating projections of the perforating element, so that during the perforating and deforming operations each perforating projection in the perforating and deforming area penetrates into a hole in the mating element.

Here, such a sheet-like structure is to be understood, on the one hand, as a flat, flexible product, such as a plastic film, for example made of polyethylene, a sheet of paper or nonwoven fabric, which may also be a few millimeters thick. On the other hand, rigid boards are also meant by it. Perforated plastic films in which the edges of the holes have a specific three-dimensional shape are used, for example, for producing diapers. Until now, however, it has not been possible to perforate the plastic films and to give the edges of the holes the desired shape in one step.

It is known, for example from FR-A-1 417 619, to perforate plastic films by leading them between a needle roll having a large number of needles and a mating roll having a smooth surface. The edges of the holes which are produced in this case do not have a regular three-dimensional shape, however, since the smooth surface of the mating roll counteracts the action of turning out the edges of the holes.

Instead of mating rolls with a smooth surface, use has therefore already been made of mating rolls which are provided with grooves that are continuous in the direction of rotation of the roll and into which the needles of the needle roll can penetrate during the perforating operation, as described in U.S. Pat. No. 2,748,863. Holes with partially three-dimensional edges are then produced in the plastic films, but they do not have the ideal shape and, in particular, do not have the precisely defined shape for specific applications.

On the other hand, it is known, for example from EP-A-0 020 083, to use as the perforating element a tooth roll with teeth as perforating projections which, during the perforating and deforming operation, in the perforating and deforming area penetrate into complementarily shaped holes in the mating element. However, teeth of this type cannot be compared with needles, in as much as their entire surface is used for deformation and therefore edges of a different shape are formed in the holes on the sheet-like structure. In particular, a tooth on the basic roll body merges at the tooth attachment directly into a further tooth, so that on the sheet-like structure in each case one hole follows the preceding one directly. In addition, the sheet-like structure is pressed as far as the basic body of the tooth roll by the mating element. In addition, the entire sheet-like structure is heated if perforation and deformation are carried out with heated teeth.

In view of the disadvantages of the previously known apparatus described above, the invention is based on the following object. It is required to provide an apparatus for perforating and deforming a sheet-like structure of the type mentioned at the beginning with which, during the perforation of the sheet-like structure, the edges of the holes can be shaped three-dimensionally in a controlled manner, the intention being that in each case not the entire perforating projection comes into contact with the sheet-like structure.

This object is achieved by the apparatus according to the invention.

The essence of the invention consists in the following: an apparatus for perforating and deforming a sheet-like structure comprises a perforating element having a large number of perforating projections and a mating element which has a large number of holes to accommodate perforating projections of the perforating element, so that during the perforating and deforming operations each perforating projection in the perforating and deforming area penetrates into a hole in the mating element. The apparatus is characterized in that the perforating element is a needle element and the perforating projections are needles, each needle having a shaping area with a circumferential face between which and the inner face adjacent to it of the respective hole in the mating element, the edge of the hole produced on the sheet-like structure during the perforation and deformation of the sheet-like structure is shaped in a controlled manner.

Because the perforating projections are needles which, by definition, have a shank and a tip, and the needles have a specific shaping area, during the perforation of the sheet-like structure not the entire perforating projection comes into contact with the sheet-like structure. In particular, the sheet-like structure is not pressed as far as the basic body of the needle element by the mating element, so that in the case of a heated needle element not the entire sheet-like structure is heated. In addition, with needles, any desired distribution of the holes and a larger number of different shapes of the edges of the holes can be produced since, for example in the case of a needle element and a mating element in the form of rolls, there are fewer restrictions in relation to the interengagement of the rolls than in the case of tooth rolls rolling on each other. As a result of the shaping area of each needle, which has a circumferential face between which and the inner face adjacent to it of the respective hole in the mating element, the edge of the hole produced on the sheet-like structure during the perforation and deformation of the sheet-like structure is shaped in a controlled manner, the sheet-like structure is provided with holes with three-dimensional edges which are regular and relatively accurately shaped.

Depending on the sheet-like structure, for example in the case of plastic films, the perforating and deforming operations are carried out at elevated temperature, temperatures up to about 450° C. being used to some extent in the case of the films which are common nowadays. During the heating of the needle element and of the mating element, these expand to different extents because of their normally different composition, which has to be taken into account in order that, at the elevated temperature, the needles fit into the holes. In the case of an apparatus for perforating and deforming a sheet-like structure at elevated temperature, the needle element and the mating element are therefore formed and mounted such that after they have been heated to the temperature needed to perforate and deform the sheet-like structure, during the perforating and deforming operations each needle in the perforating and deforming area penetrates into a hole in the mating element. At the cold stage, the needle element and the mating element do not need to fit each other.

The apparatus according to the invention is advantageously constructed in such a way that, during the perforating and deforming operations, the sheet-like structure rests on the mating element, and a basic body of the needle element, bearing the needles, is spaced apart from the mating element in such a way that during the perforating and deforming operations the basic body is spaced apart from the sheet-like structure. As a result, heating of the entire sheet-like structure with a heated needle element is prevented or at least considerably restricted by the air cushion located in between.

In a preferred design variant of the apparatus according to the invention, the needles have an essentially cylindrical shank and a conical or convexly shaped tip and are preferably rotationally symmetrical. The foremost part of the tip of the needles can also be ground flat or ground flat with rounded off edges in certain design variants. By virtue of such specific needle shapes, the speed and precision of the perforating and deforming operations can be increased.

There are preferably means for heating the needles, for example an induction heating system or other commercially available electric heating elements, which can be arranged in the basic body of the needle element. The heating of the needles can assist the perforation and deformation in particular of thermoplastic material.

In the following text, the apparatus according to the invention is described in more detail using exemplary embodiments and with reference to the appended drawings, in which:

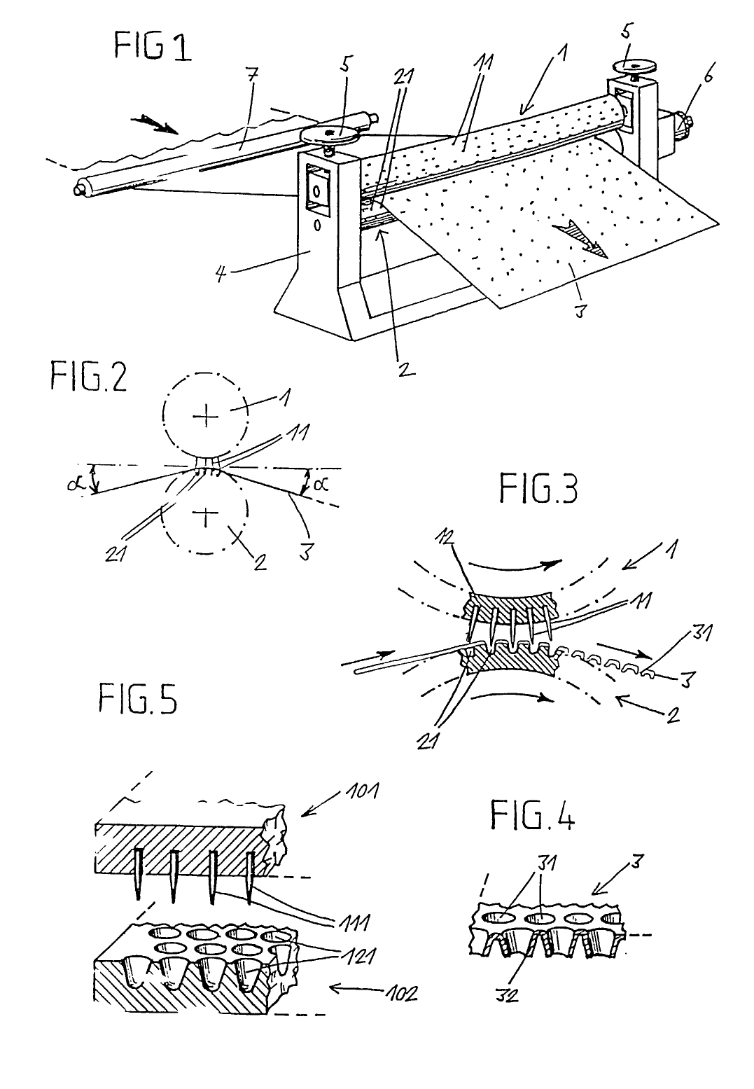

FIG. 1 shows a perspective view of a first exemplary embodiment of the apparatus according to the invention having a needle roll and a perforated roll, during the perforation and deformation of a sheet-like structure;

FIG. 2 shows a schematic illustration of the perforation and deformation of the sheet-like structure with the apparatus of FIG. 1;

FIG. 3 shows a much enlarged, partly schematic, detailed sectional view of the needle roll and of the perforated roll during the perforation and deformation of the sheet-like structure;

FIG. 4 shows part of the perforated and deformed sheet-like structure in a sectioned perspective view;

FIG. 5 shows a sectioned perspective view of a second exemplary embodiment of the apparatus according to the invention having a needle plate and a perforated plate;

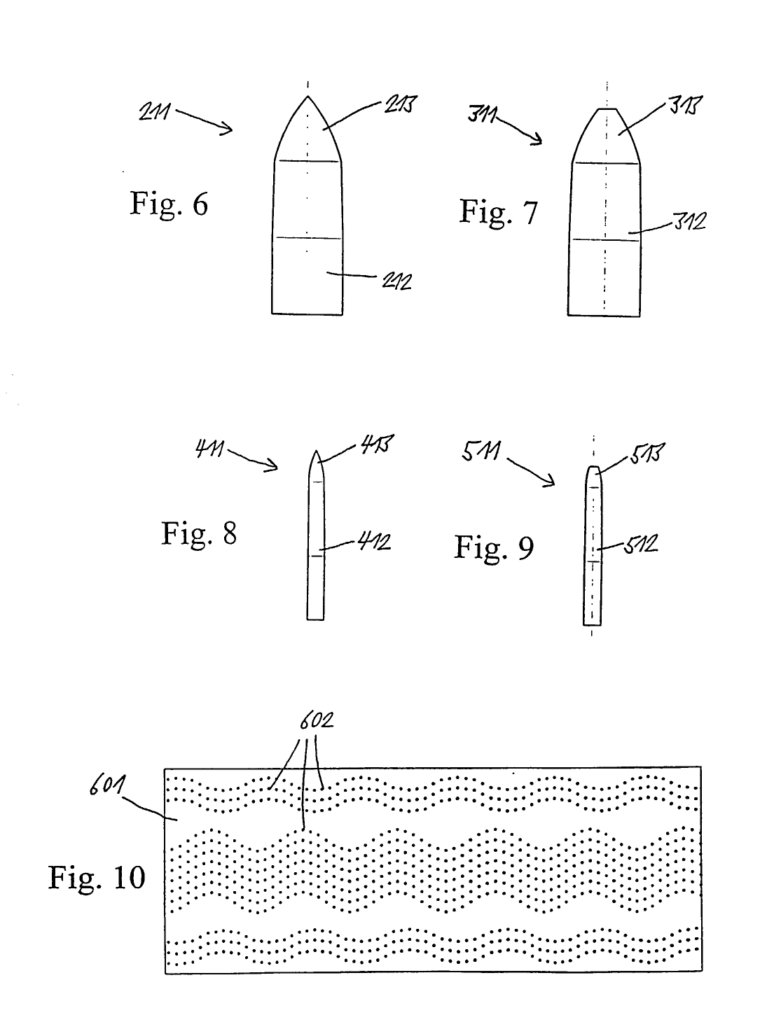

FIG. 6 shows an exemplary embodiment of a relatively thick needle with a convexly shaped tip;

FIG. 7 shows an exemplary embodiment of a relatively thick needle with a convexly shaped tip ground flat;

FIG. 8 shows an exemplary embodiment of a relatively thin needle with a convexly shaped tip;

FIG. 9 shows an exemplary embodiment of a relatively thin needle with a convexly shaped tip ground flat; and

FIG. 10 shows a projected surface of a cylindrical body of a needle roll having a needle arrangement such as is used, for example, for perforating and deforming nonwoven materials for panty-liners.

### FIGS. 1 and 2

The illustrated first exemplary embodiment of an apparatus according to the invention for perforating and deforming a sheet-like structure 3 essentially comprises a needle roll 1 with a large number of regularly arranged needles 11 and a perforated roll 2 having a large number of regularly arranged holes 21, such that during the perforating and deforming operations, each needle 11 in the perforating and deforming area penetrates into a hole 21 in the perforated roll 2. The needle roll 1 and the perforated roll 2 are rotatably mounted on a frame 4, the needle roll 1 being vertically adjustable via two adjusting wheels 5, so that the distance of the needle roll 1 from the perforated roll 2, and thus the distance of the needle roll 1 from the sheet-like structure 3 and the depth of penetration of the needles 11 into the holes 21, is adjustable. An electric motor 6 is used to drive the needle roll 1 and the perforated roll 2 synchronously.

The sheet-like structure 3, coming from a preceding station in a production line over a turn roller 7, is preferably led between the needle roll 1 and the perforated roll 2 over the perforated roll 2 and subsequently fed to a next station. It is tensioned over the perforated roll 2, which permits accurate perforation, and in the present example forms an angle a with the horizontal on either side of the perforated roll 2.

Depending on the field of use, needle rolls 1 and perforated rolls 2 can have different sizes and can be provided with different numbers of needles 11 and holes 21, respectively. Use is made, for example, of rolls 1, 2 with a width of about 3.2 m with approximately 100'000 needles 11 and holes 21, respectively.

In the case of certain sheet-like structures 3, in particular in the case of plastic films, the perforating and deforming actions are carried out at elevated temperature, for example by means of a heated needle roll 1, temperatures up to about 450° C. being used to some extent in the case of the films which are common nowadays. The different expansion of the needle roll 1 and of the perforated roll 2 because of their normally different composition must be taken into account in this case during the design and arrangement of the rolls 1, 2, in order that the needles 11 fit into the holes 21 at the elevated temperature. In the normal case, a pair of rolls 1, 2 is thus designed for specific temperature ranges.

FIG. 3

It can be seen here that the needle roll 1 comprises a cylindrical body 12, in which the needles 11 are anchored, for example cast. The cylindrical body 12 is preferably made of metal, for example of brass or steel, while the needles 11 preferably consist of hardened steel. The perforated roll 2 is advantageously made, wholly or at least in its outer areas, of rubber or metal, in which holes 21 are formed, said holes tapering conically from their opening toward the interior of the perforated roll 2 until virtually at the very bottom. The needles 11 likewise taper conically approximately beginning at the center of the needle toward the tip and in this area, which is used as the shaping area, their circumferential face is approximately parallel to the inner face of the respective hole 21 into which they are inserted during the perforating and deforming operations.

In order to perforate and deform the sheet-like structure 3, the latter is led between the needle roll 1 and the perforated roll 2 in the direction of the arrow as the two rolls 1, 2 rotate in the direction of the arrow. In the process, the needles 11 perforate the sheet-like structure 3 and shape the edges of the holes 31 produced between the approximately parallel areas of the needles 11 and of the holes 21 in the perforated roll 2 in a controlled manner and three-dimensionally.

Also clearly visible is the distance between the cylindrical body 12 of the needle roll 1 and the sheet-like structure 3, which permits the needle roll 1 and the needles 11 to be heated without the entire sheet-like structure 3 being heated.

FIG. 4

As a result of the perforation and deformation of a flat sheet-like structure 3 by means of the apparatus according to the invention as shown in FIGS. 1 to 3, the illustrated perforated and deformed sheet-like structure 3 is obtained, which has uniformly distributed holes 31 with conical edges 32 which are more regularly shaped by comparison with the prior art.

FIG. 5

The perforated and deformed sheet-like structure 3 of FIG. 4 can also be produced by means of the illustrated second exemplary embodiment of the apparatus according to the invention. In this exemplary embodiment, instead of a needle roll 1 there is a needle plate 101 with needles 111, and instead of a perforated roll 2 there is a perforated plate 102 with holes 121′. The perforation and deformation of the sheet-like structure 3 is not carried out continuously, but section by section. Otherwise, what was stated in connection with the first exemplary embodiment applies.

FIGS. 6 to 9

Illustrated here as exemplary embodiments of possible needles are a needle 211 with a relatively thick cylindrical shank 212 and convexly shaped, complete tip 213, a needle 311 with a relatively thick cylindrical shank 312 and convexly shaped tip 313 ground flat, a needle 411 with a relatively thin cylindrical shank 412 and convexly shaped, complete tip 413, and a needle 511 with a relatively thick cylindrical shank 512 and convexly shaped tip 513 ground flat.

Apart from these, countless other needle shapes are conceivable. The important factor is that the needles, which by definition comprise a shank and a tip, have a specific shaping area for shaping the edge of the hole, so that during the perforation of the sheet-like structure, not the entire needle comes into contact with the sheet-like structure.

FIG. 10

Depending on the application, the needles can be arranged on the needle elements in specific patterns-or even irregularly. The illustration shows a projected surface 601 of a cylindrical body of a needle roll with holes 602 for anchoring needles, in an arrangement as is used, for example, for perforating and deforming nonwoven materials for panty-liners.

Further design variations of the above described apparatus for perforating and deforming a sheet-like structure can be implemented. Mention should also expressly be made here of:

The approximately parallel shaping areas of the needles 11; 111; 211; 311; 411; 511 and the associated holes in the perforated roll 2 or the perforated plate 102 do not necessarily have to taper conically or convexly. Other shapes, such as a cylindrical shape, are also possible.

Instead of designing pairs of rolls 1, 2 or pairs of plates 101, 102 for specific temperature ranges, in principle it would also be conceivable to construct these by means of suitable material selection such that they expand to the same extent in the event of an increase in temperature, and thus can be used in all the relevant temperature ranges.

Many different variants are conceivable for the suspension and movement of the needle roll 1 and perforated roll 2 or needle plate 101 and perforated plate 102. What is primarily important is that their mutual alignment during the perforating and deforming operations is correct.

1. An apparatus for perforating and deforming a sheet-like structure, having a perforating element with a large number of perforating projections and having a mating element which has a large number of holes to accommodate perforating projections of the perforating element, so that during the perforating and deforming operations each perforating projection in the perforating and deforming area penetrates into a hole in the mating element, wherein the perforating element is a needle element and the perforating projections are needles, each needle having a shaping area with a circumferential face between which and the inner face adjacent to it of the respective hole in the mating element, the edge of the hole produced on the sheet-like structure during the perforation and deformation of the sheet-like structure is shaped in a controlled manner.

2. The apparatus as claimed in claim 1, wherein the needle element and the mating element are formed and mounted such that after they have been heated to the temperature needed to perforate and deform the sheet-like structure, during the perforating and deforming operations each needle in the perforating and deforming area penetrates into a hole in the mating element.

3. The apparatus as claimed in claim 2, wherein the needle element and the mating element have at least one needle or one hole respectively per 10 cm².

4. The apparatus as claimed in claim 1, wherein the holes taper at least approximately conically from their opening toward the interior of the mating element, at least down to a certain depth.

5. The apparatus as claimed in claim 1, wherein in the case of each needle, the circumferential face in the shaping area is approximately parallel to the inner face of the respective hole in the mating element into which it is inserted during the perforating and deforming operations.

6. The apparatus as claimed in claim 1, wherein the depth of penetration of the needles into the holes is adjustable.

7. The apparatus as claimed in claim 1, wherein the mating element is made of rubber or metal and the needle element is made of metal, the needles preferably being made of hardened steel.

8. The apparatus as claimed in claim 1, wherein the needle element is a needle roll and the mating element is a perforated roll.

9. The apparatus as claimed in claim 8, wherein it has means to rotate the needle roll and the perforated roll synchronously.

10. The apparatus as claimed in claim 1, wherein the needle element is a needle plate and the mating element is a perforated plate.

11. The apparatus as claimed in one of claims 1 to 10, wherein it is constructed in such a way that during the perforating and deforming operations, the sheet-like structure rests on the mating element, and a basic body of the needle element, bearing the needles, is spaced apart from the mating element in such a way that during the perforating and deforming operations, the basic body is spaced apart from the sheet-like structure.

12. The apparatus as claimed in claim 11, wherein the distance between the basic body of the needle element and the mating element is adjustable.

13. The apparatus as claimed in one of claims 1 to 10, wherein the needles have an essentially cylindrical shank and a conical or convexly shaped tip and are preferably rotationally symmetrical.

14. The apparatus as claimed in claim 13, wherein the foremost part of the tip of the needles is ground flat or ground flat with rounded off edges.

15. The apparatus as claimed in one of claims 1 to 10, wherein it has means for heating the needles.

16. A method of perforating and deforming a sheet-like structure with an apparatus for perforating and deforming a sheet-like structure, which comprises a needle element having a large number of needles and a mating element having a large number of holes to accommodate needles of the needle element, wherein the needles in the perforating and deforming area are each inserted into a hole in the mating element and perforate the sheet-like structure in the process and, at the same time, the respective edge of the hole on the sheet-like structure is shaped in a controlled way between a circumferential face of a shaping area of each needle and the inner face adjacent to it of the respective hole in the mating element.

17. The method as claimed in claim 16, wherein the needles are heated during the perforating and deforming operations.
